(19) United States
(12) Patent Application Publication
(10) Pub. No.: US 2024/0037468 A1
(43) Pub. Date: Feb. 1, 2024

(54) METHOD OF MONITORING PROJECT PROCESS AND OUTCOME

(71) Applicant: Sunny Singh Dhaliwal, Vancouver (CA)

(72) Inventor: Sunny Singh Dhaliwal, Vancouver (CA)

(21) Appl. No.: 17/815,939

(22) Filed: Jul. 28, 2022

(51) Int. Cl. G06Q 10/06; G06Q 40/06

(52) U.S. Cl. CPC G06Q 10/063118; G06Q 10/063114; G06Q 40/06

(57) ABSTRACT

A project monitoring method facilitated by a software application wherein the present invention provides a unique method that allows multiple entities involved in a project to receive updates thereon and further facilitate an improved communication workflow. The present invention includes a software application wherein the software application is operable to provide project creation wherein plans, drawings or similar material is uploaded into the software for the project. A user will identify a location coordinate on the plans or drawings and be able to upload a captured image of that identified location coordinate from the actual jobsite or area of the plan. This captured image is made available to other entities involved in the project and the present invention further facilitates communication therebetween. The present invention further provides the ability to annotate the images or location coordinate and provide notification of updates to all entities assigned to the project.

### FIELD OF THE INVENTION

The present invention relates generally to construction and design projects, more specifically but not by way of limitation, a method facilitated by a software application wherein the present invention provides enablement of project monitoring for professions such as but not limited to realtors, stagers, designers and contractors wherein progress of the project is linked to drawings such as but not limited to engineered construction plans.

### BACKGROUND

Professionals such as but not limited to general contractors and interior designers must manage and communicate with multiple groups of individuals during a project. By way of example but not limitation, during a new construction or a remodel, a general contractor must manage a plurality of subcontractors, engineers, inspectors and stakeholders. This process is quite cumbersome and can be difficult for the general contractor to manage in an effective manner. During any type of build the general contractor will be required to communicate with at least one engineer to discuss the engineered plans from which the construction project is based and must follow. A general contractor will then have to communicate with a plurality of subcontractors typically in a sequence during the project and ensure that each subcontractor is following the plans and completing the work as required. During these steps, physical inspection is often required and additionally there may be inspections by local regulatory authorities at various intervals during the process. During this process the general contractor must communicate with inspectors, designer, subcontractors and the stakeholder which is currently executed in a manual manner utilizing conventional communication techniques and reporting.

One issue with the current methodology of managing the aforementioned types of projects is the inefficient communication and reporting. Most often the general contractors must communicate with and supervise the work of all subcontractors. As the subcontractors complete the work, the general contractor must then validate the work completed with the building plans and further ensure the quality of the work. Ensuing the quality inspection and validation, the general contractor will typically create a report for the stakeholders that is most often delivered via email or other conventional method. This report contains pertinent information about the task completed and can often include photographs of the work completed. Additionally, the report may include any inspection results by local regulatory authorities which would have also had to be scheduled and managed by the general contractor. During review the stakeholder must then analyze the report and make a manual comparison to the building plans to ensure the work completed was according to plan. This aforementioned process is time consuming and inefficient which often results in delays in completion of the project.

Accordingly, there is a need for a method that can be facilitated by a software application wherein the present invention would provide an improved technique to manage subcontractors, evaluate work quality and completion and further provide timely information to stakeholders of the project.

### SUMMARY OF THE INVENTION

It is the object of the present invention to provide a software application that facilitates a method configured to provide management of a plurality of entities and tasks during projects such as but not limited to buildouts and interior design wherein the present invention includes the ability to upload construction drawings and the like into the software application.

Another object of the present invention is to provide a method to improve communication between general contractors, subcontractors and stakeholders during the process of a construction or similar project wherein the software application of the present invention provides identification of a coordinate of a drawing loaded into the software.

A further object of the present invention is to provide a software application that facilitates a method configured to provide management of a plurality of entities and tasks during projects such as but not limited to buildouts and interior design wherein the present invention provides an ability to link a coordinate of a location on a plan drawing and a photograph of progress at that location on the job site.

Still another object of the present invention is to provide a method to improve communication between general contractors, subcontractors and stakeholders during the process of a construction or similar project wherein the software application of the present invention facilitates the ability to upload photographs of progress of the project and map the photographs to a specific location coordinate of an image of the building plan or similar type drawings.

An additional object of the present invention is to provide a software application that facilitates a method configured to provide management of a plurality of entities and tasks during projects such as but not limited to buildouts and interior design wherein the present invention wherein the photograph of the progress at a location of a job site remains linked to the location coordinate on the image of the building plan or similar drawings.

Yet a further object of the present invention is to provide a method to improve communication between general contractors, subcontractors and stakeholders during the process of a construction or similar project wherein the software application of the present invention facilitates the ability for any user to input notes at the location coordinate on the image of the building plan or similar drawing.

Another object of the present invention is to provide a software application that facilitates a method configured to provide management of a plurality of entities and tasks during projects such as but not limited to buildouts and interior design wherein the present invention further includes the ability to assign contacts and owners to any portion of the project and link with the location coordinate.

An alternative object of the present invention is to provide a method to improve communication between general contractors, subcontractors and stakeholders during the process of a construction or similar project wherein the software application of the present invention facilitates the ability to provide an updated picture for the location coordinates and further provide notification to all contacts and owners associated therewith.

Yet a further object of the present invention is to provide a software application that facilitates a method configured to provide management of a plurality of entities and tasks during projects such as but not limited to buildouts and interior design wherein the software application provides the ability to share drawings with all parties involved in the project.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is an outline of the method of the present invention; and

FIG. 2 is an outline of an exemplary portion of the present invention for contractor management.

### DETAILED DESCRIPTION

Referring now to the drawings submitted herewith, wherein various elements depicted therein are not necessarily drawn to scale and wherein through the views and figures like elements are referenced with identical reference numerals, there is illustrated a project monitoring method 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

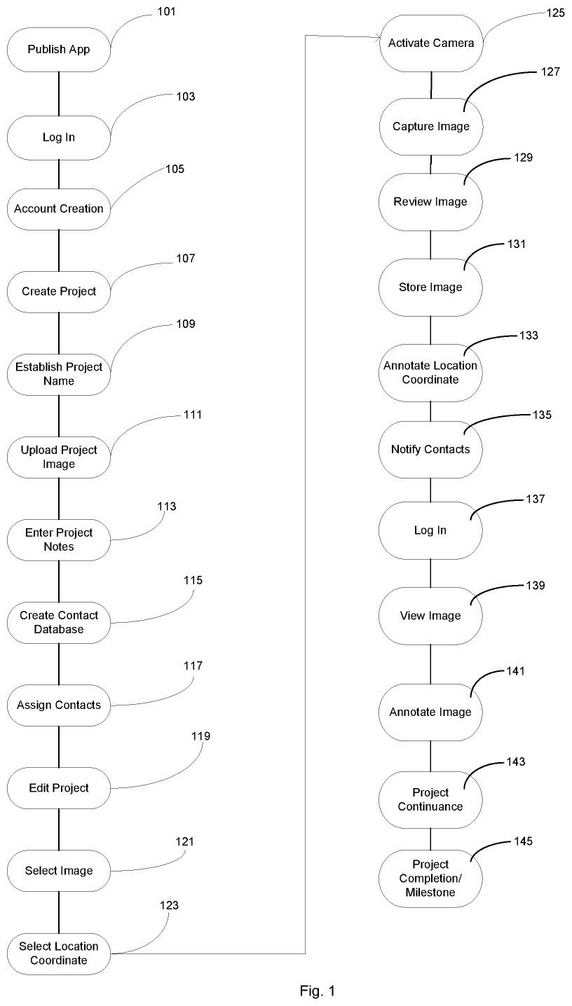

Referring in particular to the Figures submitted herewith, the project monitoring method 100 is executed via a software application wherein it should be understood within the scope of the present invention that the software application is operated on computing devices such as but not limited to desktop and mobile computing devices. Now referring to FIG. 1 herein, an exemplary process of utilizing the project monitoring method 100 is outlined therein. It should be understood within the scope of the present invention that the step ordering is exemplary and that some of the steps illustrated and discussed herein could be repeated, omitted or excluded during actual engagement with the project monitoring method 100. In step 101, the software application configured to execute the project monitoring method 100 is published to a website, application store or other suitable location so as to be available for download to a computing device. Step 103, ensuing downloading the software application of the present invention, a user will login into the software application to initiate utilization thereof. In step 105, the user will commence utilization of the project monitoring method 100 with creating an account specific to the user. It should be understood within the scope of the present invention that the account creation would include collection of parameters such as but not limited to name, address, email, payment method and the like.

In step 107, the user will initiate creation of a project. It should be understood within the scope of the present invention that the present invention could be employed by professions such as but not limited to realtors, stagers, designers and contractors. Those skilled in the art will recognize that core fundamentals co-exist across the delivery of the service of these professions but unique characteristics reside as well. In step 109, the project is assigned a name or some suitable identification within the software of the present invention and a data file is created for the project. Step 111, the user will upload the initial project information which will be either an engineered drawing, photo or some similar type of data that provides a layout and/or design scope intention of the project. It should be understood within the scope of the present invention that the initial project data could be a file such as but not limited to an image file or .pdf file. In step 113, the user will enter any necessary project notes concerning the project. It should be understood within the scope of the present invention that the project notes could be but are not limited to completion schedule, environmental conditions and job requirements. In step 115, the user will create a contact database. The contact database is a data set that contains names and contact information of other entities and/or individuals that could be involved in one or more of the projects being managed by the project monitoring method 100. Step 117, the user will assign or associate the desired contacts from the contact database to the project. It should be understood within the scope of the present invention that the user could create more than one project and execute the steps discussed herein for multiple projects.

In step 119, the user will access the software application to initiate editing of the project process. This is executed by accessing the original project data file that contained drawings and/or images of the project layout. Step 121, the user will select one of the drawings/images of the project. Step 123, the user will select a specific location coordinate on the image wherein this location coordinate is the location that represent the location of the actual job site where work has occurred and an update of that work needs to be recorded into the project within the software application of the present invention. It should be understood within the scope of the present invention that selection of location coordinate on the project drawing could be executed with a cursor location or engaging a touch screen wherein either will mark the location on the drawing file stored within the software application. In step 125, the user will activate a camera on a remote computing device while at the jobsite and proximate the location coordinate selected on the project drawings. Step 127, the user will capture an image file of the jobsite that represents the location coordinate selected on the project drawing. In step 129, the user will review the image to ensure the desired information was captured therein. Step 131, the user will store the captured image in the project file wherein the image will be associated and linked to the specific location coordinate selected. In step 133, the user will provide any desired annotations for the location coordinate and the captured image wherein the user and any contact viewing the project file will be provided an icon at the location coordinate displaying that an image and annotations have been created for the selected location coordinate. It should be understood within the scope of the present invention that the user could select multiple location coordinates and upload an image file while at a jobsite.

In step 135, ensuing at least one new captured image being uploaded to the project file for a location coordinate, the software application will provide a notification to all or some of the contacts assigned to the project file. It should be understood that this notification could be a SMS text message, email or other suitable notification. Step 137, a notified contact will login into the software application of the project monitoring method 100. In step 139, ensuing access of the software application and the project data file, the contact will be presented the location coordinate and access the captured image file along with any associated annotations. In step 141, the contact will create their own annotation which is stored at the location coordinate and is available for viewing by the user and all other contacts assigned to the project. It should be understood within the scope of the present invention that the annotation entered by the contact could be but is not limited to stakeholder approval, corrective action notes or an inquiry to the user or contact that uploaded the captured image for a location coordinate. In step 145, the aforementioned will continue for the project until either project completion or a project milestone is achieved.

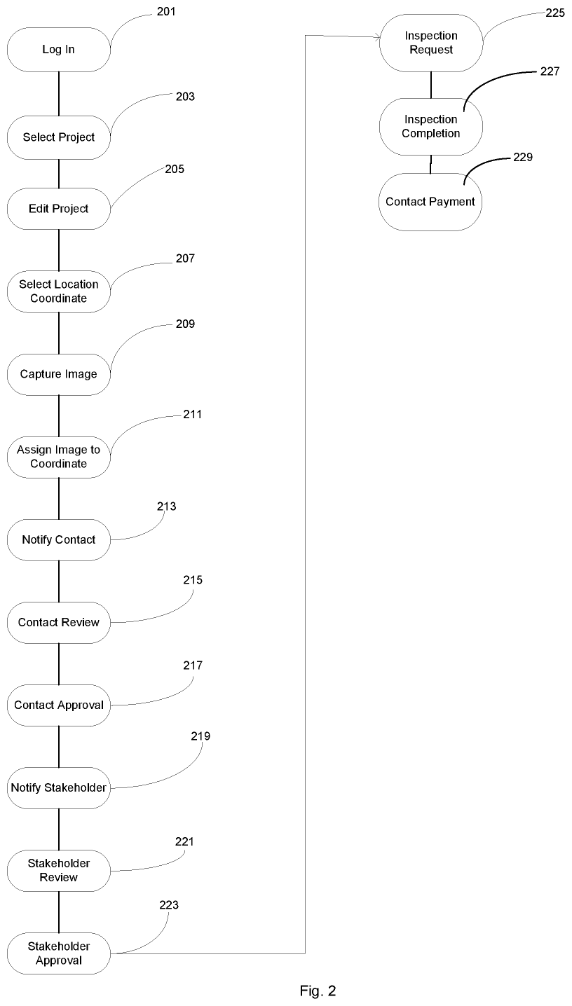

Now referring to FIG. 2 submitted as a part hereof, an outline specific to subcontractor management during a project utilizing the software application executing the project monitoring method 100 is outlined therein. In step 201, a user, byway of example but not limitation a subcontractor, access the software application of the present invention. Step 203, the subcontractor will select a project that has been created within the software application of the present invention. In step 205, the subcontractor will initiate an edit of the project. Step 207, the subcontractor will select a location coordinate on the drawings in the project data file wherein the location coordinate represents an area of work completion or progress for which the subcontractor needs to provide an update. Step 209, the subcontractor will capture an image from the job site that is the physical location of the location coordinate selected on the project drawing file. In step 211, the subcontractor will assign the captured image to the selected location coordinate on the project drawing file. Step 213, ensuing assignment of the captured image to the selected location coordinate, the software application will notify the general contractor associated with the project. In step 215, the general contractor will receive the notification and access the software application to execute a review of the uploaded captured image placed at the location coordinate by the subcontractor. Step 217, ensuing review of the uploaded image the general contractor will utilize the software to enter an approval of the work completed by the subcontractor that was represented in the captured image file. In step 219, ensuing the general contractor approval, the software application will transmit a notification to the project stakeholder. Step 221, the project stakeholder will access the software application of the present invention and perform a review of the captured image at the location coordinate for which the general contractor provided approval of the work completed by the subcontractor.

In step 223, ensuing review of the capture image, the project stakeholder enters their approval into the software application executing the present invention. Step 225, subsequent the project stakeholder approval, if required, the software application will transmit an inspection request to any required local regulatory authorities. In step 227, ensuing receipt of the inspection request, the local regulatory authorities will execute an inspection and provide an inspection report to the general contractor recording completion of the inspection. In step 229, the software application upon receiving all approvals and notification of completed inspection will execute transmission or authorization of payment to the subcontractor.

It should be understood within the aforementioned exemplary process facilitated by the software application of the project monitoring method 100 that variations thereof could occur and remain within the spirit and scope of the present invention. Additionally, it should be understood that the aforementioned exemplary process discussed herein and diagrammed in FIG. 2 submitted as a part hereof could be applied to other professions such as but not limited to designers, stagers and realtors.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A method for monitoring progress of a project and further facilitate communication between all entities associated with the project wherein the method comprises the steps thereof:
providing a software application, said software application being stored on a computing device wherein the computing device is accessible via conventional communication protocols;
downloading the software application, wherein users download the software application onto a remote computing device;
creating an account within the software application, wherein users of the software application enter identification parameters to be stored within a user account;
establishing a project, wherein a user will establish a project and store within the software application;
uploading at least one image of the project, wherein the user will upload at least one image to the software application to be stored within a project data file;
selecting a location coordinate, wherein the user will select a location coordinate on the at least one image wherein the location coordinate is an area for which an update to the project is desired;
capturing an image of an area of the project, wherein the user will capture an image of an area of a project site wherein the area is the location coordinate selected on the at least one image;
storing the image, wherein the image capture by the user of the area is stored in the project data file with an icon representing thereof being located at the location coordinate;
transmitting a notification to other users, wherein the software application provides notification to users associated with the project; and
reviewing the captured image, wherein at least one of the other users accesses the software application and reviews the captured image representing the location coordinate on the at least one image of the project.

2. The method for monitoring progress of the project and further facilitate communication between all entities associated with the project as recited in claim 1, and further including a step of entering project notes, wherein the user will annotate the captured image and provide notes thereon.

3. The method for monitoring progress of the project and further facilitate communication between all entities associated with the project as recited in claim 2, wherein the at least one image of the project is a construction plan.

4. The method for monitoring progress of the project and further facilitate communication between all entities associated with the project as recited in claim 2, and further including a step of assigning a group of users to the project, wherein the user will assign a plurality of users to the project.

5. The method for monitoring progress of the project and further facilitate communication between all entities associated with the project as recited in claim 4, and further including a step of transmitting a notification to the plurality of users, wherein subsequent the user uploading the captured image and storing into the project data file a notification is transmitted to the plurality of users by the software application.

6. The method for monitoring progress of the project and further facilitate communication between all entities associated with the project as recited in claim 5, and further including a step of capturing a second image from a location at the project site, wherein the second image is uploaded into the software application.

7. The method for monitoring progress of the project and further facilitate communication between all entities associated with the project as recited in claim 6, and further including a step of selecting a second location coordinate on the at least one image of the project.

8. The method for monitoring progress of a project and further facilitate communication between all entities associated with the project as recited in claim 7, and further including a step of assigning the second image to the second location coordinate.

9. The method for monitoring progress of a project and further facilitate communication between all entities associated with the project as recited in claim 8, and further including a step of reviewing the second image, wherein at least one of the plurality of user assigned to the project reviews the second image.

10. The method for monitoring progress of a project and further facilitate communication between all entities associated with the project as recited in claim 9, and further including a step of entering approval of the captured image, wherein the user will enter approval into the software application and wherein the software application will transmit the approval to the plurality of users.

11. The method for monitoring progress of a project and further facilitate communication between all entities associated with the project as recited in claim 10, and further including a step of authorizing a payment, wherein ensuing transmission of the approval the software application provides payment authorization to at least one of the plurality of users assigned to the project.

12. A method for facilitating communication between a plurality of individuals associated with a project and further assisting with project updates thereon wherein the method comprises the steps thereof:
providing a software application, said software application being stored on a computing device wherein the computing device is accessible via conventional communication protocols;
downloading the software application, wherein the plurality of individuals download the software application onto remote computing devices;
creating an account within the software application, wherein the plurality of individuals of the software application enter identification parameters to be stored within user accounts for each of the plurality of individuals;
establishing a project, wherein one of the plurality of individuals will establish a project and store within the software application;
uploading an image of the project, wherein one of the plurality of individuals will upload the image to the software application to be stored within a project data file, wherein the image is a drawing data file of the project;
selecting a location coordinate, wherein one of the plurality of individuals will select a location coordinate on the drawing data file, wherein the location coordinate is an area for which an update to the project is desired;
capturing an image of an area of the project, wherein one of the plurality of individuals will capture an image of an area of a project site wherein the area is the location coordinate selected on drawing data file;
storing the image, wherein the image capture by the one of the plurality of individuals of the area is stored in the project data file with a graphical icon being displayed at the location coordinate;
transmitting a notification to other users, wherein the software application provides notification to users associated with the project;
reviewing the captured image, wherein at least one of the other users accesses the software application and reviews the captured image representing the location coordinate on the at least one image of the project;
notifying a stakeholder, wherein the software application will transmit a notification to a stakeholder of the project; and
offering approval of the image, wherein the stakeholder will enter approval of the image of the project site associated with the location coordinate.

13. The method for facilitating communication between a plurality of individuals associated with a project and further assisting with project updates as recited in claim 12, and further including a step of transmitting an inspection request, wherein the software application will transmit the inspection request to regulatory authorities.

14. The method for facilitating communication between a plurality of individuals associated with a project and further assisting with project updates as recited in claim 13, and further including a step of authorizing payment to one of the plurality of individuals, wherein the software application will provide authorization of payment to one of the plurality of individuals ensuing receipt of approval from the stakeholder.

15. The method for facilitating communication between a plurality of individuals associated with a project and further assisting with project updates as recited in claim 14, and further including a step of annotating the image, wherein at least one of the plurality of individuals provides annotation of the image uploaded into the software application.

16. The method for facilitating communication between a plurality of individuals associated with a project and further assisting with project updates as recited in claim 15, and further including a step of adding an updated picture of the project site linked with the selected location coordinate.
